(19) United States
(12) Patent Application Publication
(10) Pub. No.: US 2007/0143992 A1
(43) Pub. Date: Jun. 28, 2007

(54) METHOD FOR MANUFACTURING WIRING BOARD

(75) Inventor: Masahiro Kyouzuka, Nagano-shi, Nagano (JP)

Correspondence Address: RANKIN, HILL, PORTER & CLARK LLP, 4080 ERIE STREET, WILLOUGHBY, OH, 44094-7836, US

(73) Assignee: SHINKO ELECTRIC INDUSTRIES CO., LTD., Nagano-shi (JP)

(21) Appl. No.: 11/611,563

(22) Filed: Dec. 15, 2006

(30) Foreign Application Priority Data
Dec. 26, 2005 (JP) 2005-372614

(51) Int. Cl. H01R 4/24; B32B 37/00

(52) U.S. Cl. 29/830; 439/408; 29/831; 29/846; 29/847; 156/256

(57) ABSTRACT

In a method for manufacturing a wiring board in which two base members 10 made of metal are pasted in a manner that one side surfaces thereof are opposed and pasted to each other, then a wiring board formed by plural layers is formed on the other surface of each of the base members 10, then both the base members 10 are separated from each other, and the base members 10 are removed thereby to obtain wiring boards separately, in the case of pasting the two base members 10, a mold release agent in a liquid state is coated or printed on a portion except for the peripheral portion of the one side surface of each of the two base members 10, and an adhesive agent resin sheet 11 is disposed between the two base members 10 thereby to paste the peripheral portions of the base members 10 being attached with no mold release agent to each other by the adhesive agent resin sheet 11.

### BACKGROUND OF THE INVENTION

The present invention relates to a method for manufacturing a wiring board and more particularly relates to a method for manufacturing a wiring board provided with a wiring pattern by using a base member made of metal.

As methods for manufacturing wiring boards, there is a method in which, after forming a multi-layer wiring board on a base member made of metal, the base member is etched away by etchant thereby to obtain the wiring board. That is, the base member is used as a supporting plate.

Further, in this case, as shown in FIG. 7, two base members 4, 4 are opposed and pasted to each other at their peripheral portions by an adhesive agent 6, then wiring boards 8, 8 are formed on the base members 4, 4, respectively, then, the pasted base members are cut at the inside positions of the adhesive agent 6 to separate the base members 4, 4, then the base members 4, 4 are molten and removed thereby to separately form two wiring boards 8, 8 (JP-A-2004-111520). According to this method, since the multi-layer wiring boards 8, 8 are formed on the two metal plates pasted to each other, the warpage of the wiring board can be prevented advantageously.

[Patent Document 1] JP-A-2004-111520

However, according to the aforesaid method for manufacturing the wiring board, since the peripheral portions of the base members 4, 4 are pasted to each other by the adhesive agent 6, the base members 4, 4 bend by an amount corresponding to the thickness of the adhesive agent layer (at least 10 μm or more), and so each of insulation layers respectively formed on the surfaces of the base members 4, 4 likely causes a step portion. Thus, there arises a problem that it is difficult to manufacture a wiring pattern with a good size accuracy. In particular, in the case of forming the insulation layers in the multilayer fashionby the thermal compression, the aforesaid step portions likely occur since the pressure is applied in the forming process.

### SUMMARY OF THE INVENTION

Accordingly, the invention is made in order to solve the aforesaid problem of the related arts and an object of the invention is to provide a method for manufacturing a wiring board which can form a wiring pattern with a good size accuracy without causing any step portion at an insulation layer.

In order to attain the aforesaid object, according to the first aspect, there is provided a method for manufacturing a wiring board including the steps of:

pasting two base members made of metal in a manner that one side surfaces thereof are opposed to paste to each other,

forming a wiring board by plural layers on the other surface of each of the base members,

separating both the base members from each other, and

removing the base members to obtain wiring boards separately, wherein

in a case of pasting the two base members, a mold release agent in a liquid state is coated or printed on a portion except for a peripheral portion of the one side surface of each of the two base members, and an adhesive agent resin sheet is disposed between the two base members to paste the peripheral portions of the base members being attached with no mold release agent to each other by the adhesive agent resin sheet.

Further, according to the second aspect, there is provided the method according to the first aspect, wherein

a thermosetting resin sheet is used as the adhesive agent resin sheet.

Further, according to the second aspect, there is provided the method according to the first or second aspect, wherein

insulation layers between the wiring boards each formed by the plural layers are formed by subjecting an insulation resin sheet to a thermo compression bonding.

According to the invention, in the case of pasting the base members to each other, the mold release agent is attached to a desired portion (area A) of the base members, and then the base members are pasted at only the peripheral portions (areas B) by means of the adhesive agent resin sheet. Thus, since the thickness of the mold release agent is substantially zero, no step portion is caused at the time of subjecting the insulation layers to the thermo compression bonding and so the wiring patterns can be advantageously formed with a quite good accuracy.

### BRIEF DESCRIPTION OF THE DRAWINGS

FIG. 1 is an explanatory diagram showing an area A where a mold release agent is attached.

FIG. 2 is an explanatory diagram showing a state where two base members are pasted to each other.

FIGS. 3A to 3E are explanatory diagrams showing a manufacturing procedure for manufacturing a wiring board by a method for manufacturing a wiring board according to the invention.

FIGS. 4A to 4D are explanatory diagrams showing a manufacturing procedure for manufacturing a wiring board by the method for manufacturing a wiring board according to the invention.

FIGS. 5A to 5D are explanatory diagrams showing a manufacturing procedure for manufacturing a wiring board by the method for manufacturing a wiring board according to the invention.

FIG. 6 is a sectional diagram showing the configuration of a semiconductor device in which a semiconductor element is mounted on the wiring board formed by the method according to the invention.

FIG. 7 is an explanatory diagram showing a state where two base members are pasted to each other in a related art.

### DETAILED DESCRIPTION OF THE PREFERRED EMBODIMENTS

Hereinafter, the preferred embodiment of the invention will be explained with reference to the accompanying drawings.

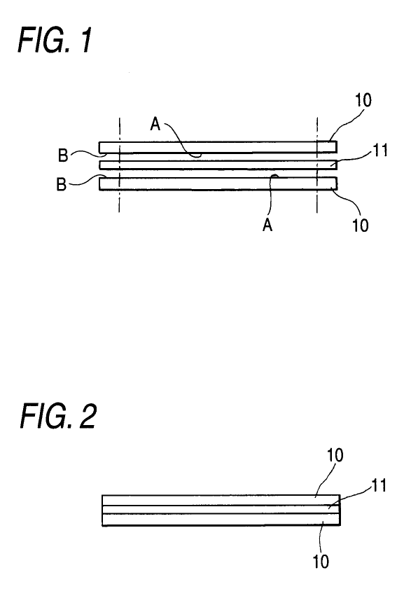

FIGS. 1 to 5 show the manufacturing procedure for manufacturing a wiring board having solder bumps for mounting a semiconductor element, as the embodiment of the manufacturing procedure of the wiring board according to the invention.

In this embodiment, two base members each formed by metal are pasted to each other, then solder bumps and a wiring pattern are formed on one surface of each of the base members, then the pasted base members are separated into two pieces and the base members are molten and removed thereby to separately form two wiring boards. Hereinafter, the explanation will be made in the manufacturing order of the procedure.

As shown in FIGS. 1 and 2, the one surfaces of two base plates 10, 10 are opposed to each other, then an adhesive agent resin sheet 11 having the same size as the base plates 10 and also having a uniform thickness is placed between the two base plates, and these base plates 10, 10 are pasted at the narrow-width peripheral portions thereof by the adhesive agent resin sheet 11. To this end, mold release agent in a liquid state is coated or printed in advance on an area A on each of the opposing one surfaces of the two base plates 10, 10. The mold release agent in the liquid state may be coated or printed by spraying the agent, for example, and so the thickness of the agent can be made quite thin (substantially zero).

It is preferable to use a thermosetting resin sheet as the adhesive agent resin sheet 11 so as to be durable in a heating process executed later.

As described above, since the base plates 10, 10 attached with the mold release agent are subjected to the thermo compression bonding via the adhesive agent resin sheet 11, both the base plates 10, 10 are bonded and pasted to each other by the adhesive agent resin sheet 11 at the small-width peripheral portions B of the base plates where no mold release agent is attached.

As the mold release agent, mold release agent containing fluorine or silicon used for separating plastics from a mold may be used.

In the case of separating the base member 10, the base members are cut at the inside positions thereof which are pasted to each other via the adhesive agent resin sheet 11, whereby both the base members 10, 10 and the adhesive agent resin sheet 11 are separated from one another.

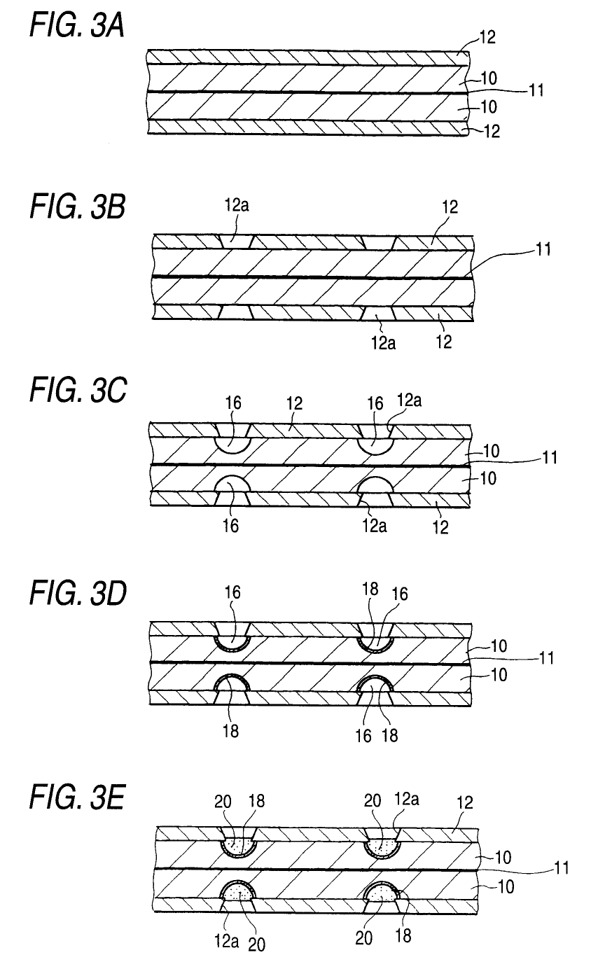

FIG. 3A shows a state where each of the other surfaces of the pasted two base members 10, 10 is covered by an insulation layer 12 having electrically insulative property. The insulation layer 12 may be formed by subjecting a resin film having the electrically insulative property such as a polyimide film to the thermo compression bonding.

FIG. 3B shows a state where holes 2a are formed in each of the insulation layers 12. The opening holes 12a are formed so as to be positioned with the electrodes of a semiconductor element and have diameters matched to the diameter sizes of solder bumps to be joined to the electrodes, respectively. The opening holes 12a can be formed by subjecting the insulation layer 12 to the laser processing or the etching processing. In the case of forming the opening holes 12a, as shown in the figure, each of the opening holes 12a is preferably formed in a tapered shape in a manner that the diameter of the inner surface thereof is made larger on the opening side.

FIG. 3C shows a state where the portions of each of the base members 10 corresponding to the opening portions are chemically etched away by using the insulation layer 12 provided with the opening holes 12a as a mask thereby to form bump holes 16. Since the base member is etched away at the portions corresponding to the opening portions of the insulation layer 12 each opened in a circuit shape, each of the bump holes 16 is etched in a spherical shape in its inner surface. In the case of the chemical etching, the base member 10 is etched away also in the lateral directions within each of the bump holes 16, and so each of the bump holes 16 has a configuration that the diameter size at the base portion of the bump hole is larger than the diameter size of the opening hole 12a.

FIG. 3D shows a state where a barrier metal film 18 is formed on the inner surface of each of the bump holes 16 by the electrolytic plating processing using the base member 10 as a feeding layer for the plating processing. The barrier metal film 18 is used in order to prevent a compound phase from being formed at a boundary face between the base member 10 made of copper and the solder bump. A nickel film or a cobalt film may be used as the barrier metal film and maybe formed by performing a nickel plating or a cobalt plating. Since the barrier metal film 18 is removed by the etching processing in a process executed later, the barrier metal film 18 is formed by a metal which can be easily etched away without corroding the solder.

FIG. 3E shows a state where each of the bump holes 16 is filled by a solder 20 by the electrolytic solder plating. In the case of performing the solder plating, the plating is performed in a manner that not only each of the bump holes 16 is completely filled by the solder 20 but also the solder 20 partially enters into each of the opening holes 12a, whereby the solder bumps hardly separate from the board when the solder bumps are formed.

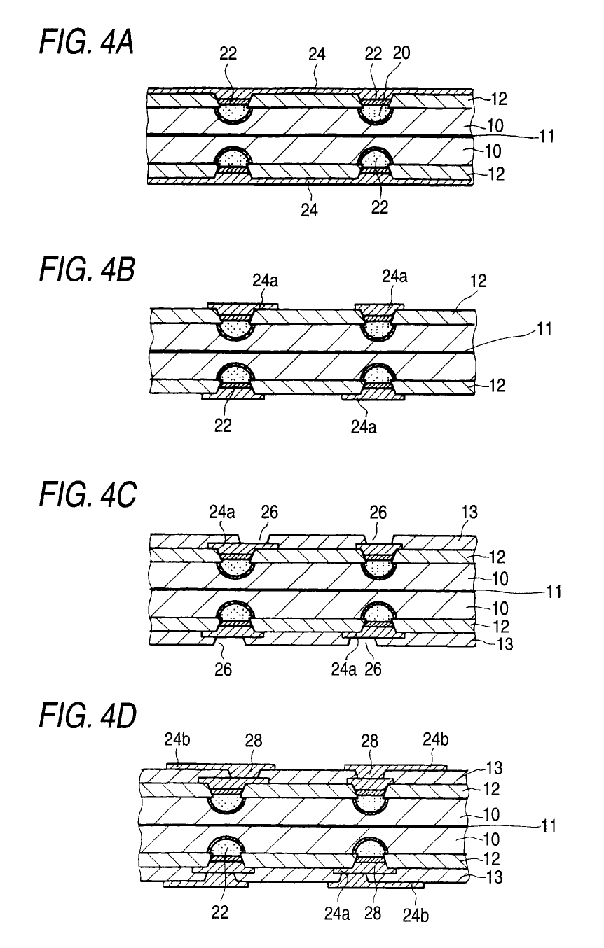

FIGS. 4A to 4D show the procedure of forming wiring patterns of plural layers in a laminated manner on the base member 10.

FIG. 4A shows a state where a barrier layer 22 is formed on the surface of the solder 20 filled in each of the bump holes 16 by the electrolytic plating using the base member 10 as a plating feeding layer, and further a copper layer 24 is formed on the inner surfaces of the opening holes 12a and the surface of the insulation layer 12 by performing the electroless copper plating and the electrolytic copper plating. The barrier layer 22 is provided in order to prevent a compound phase from being formed between the solder 20 and the copper layer 24 and is formed by the nickel plating.

FIG. 4B shows a state where the copper layer 24 is etched in a predetermined pattern thereby to form a wiring pattern 24a on the surface of the insulation layer 12.

FIG. 4C shows a state where a resin film is bonded by the thermo compression on the surface of the insulation layer 12 thereby to form an insulation layer 13 as the second layer, and via holes 26 are formed on the insulation layer 12 by the laser processing. As the method for forming the via holes 26 in the insulation layer 13, another method may be employed in which the insulation layer is formed by a photosensitive resin film and the insulation layer is exposed or developed thereby to form the via holes.

FIG. 4D shows a state where a plating seed layer is formed on the surface of the insulation layer 13 and the inner surfaces of the via holes 26, then the electrolytic copper plating is performed using the base member 10 as a plating feeding layer thereby to form a copper layer on the surface of the insulation layer 13 and the inner surfaces of the via holes 26, and the copper layer is etched in a predetermined pattern to form a wiring pattern 24b as a second layer. The wiring patterns 24a and 24b are electrically coupled through a via 28.

As the method for forming the plating seed layer on the surface of the insulation layer 13 and the inner surfaces of the via holes 26, a method for using the electroless copper plating or a method for using the spattering etc. maybe employed, for example.

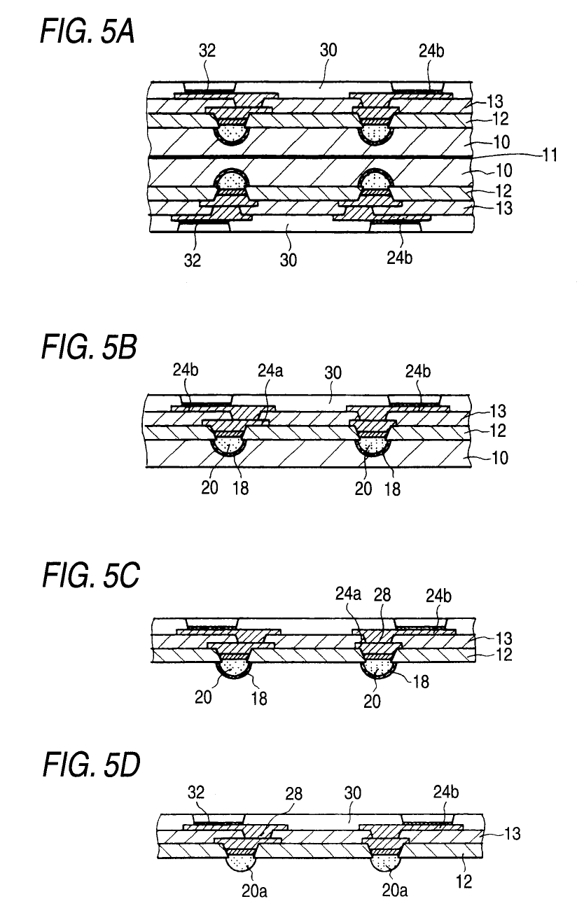

FIG. 5A shows a state where the surface of the insulation layer 13 is covered by a protection layer 30 such as a solder resist and the protection layer 30 is subjected to the patterning process thereby to form lands 32 for joining external coupling terminals in an exposed manner. The lands 32 are subjected to a required plating for the purpose of the protection thereof such as a nickel plating or a gold plating. FIG. 5B shows a state where the base members 10 are cut at the inside positions of the areas B which are pasted to each other, whereby the base members 10, 10 are separated to each other, as described above. The figure shows only one of the base members 10 thus separated. When the base members 10 are separated to each other in this manner, each of the base members 10 is configured in a manner that the wiring patterns 24a, 24b are laminated via the insulation layers 12 and 13 on the one side surface thereof.

FIG. 5C shows a state where the base members 10 are etched away. In this embodiment, the base members 10 are formed by copper, and the barrier metal film 18 is formed by a nickel film or a cobalt film which is not etched by the etchant for etching the base members 10. Thus, as shown in FIG. 5C, the base members 10 can be etched away so that the solders 20 are exposed each in a state that the external surface of the solder is covered by the barrier metal film 18.

FIG. 5D shows a state where only the barrier metal film 18 covering the external surface of the solders 20 is etched away thereby to form solder bumps 20a on the surface of the board. Only the barrier metal film 18 can be selectively etched away without corroding the solders 20 by using release liquid.

The solder bump 20a is formed by filling the solder 20 into the bump hole 16 which is formed on the other surface of the base member 10 and has the spherical shape in its inner surface. When the base member 10 is dissolved and removed and the barrier metal film 18 is removed, each of the solder bumps protrudes as a spherical bump shape via the insulation layers 12 and 13 from the surface of the wiring board on which the wiring patterns 24a and 24b are formed in the multilayer.

The wiring board is preferably formed in a manner that a large sized board is formed by simultaneously forming plural wiring boards and the board is cut at predetermined positions thereby to form the plural wiring boards separately.

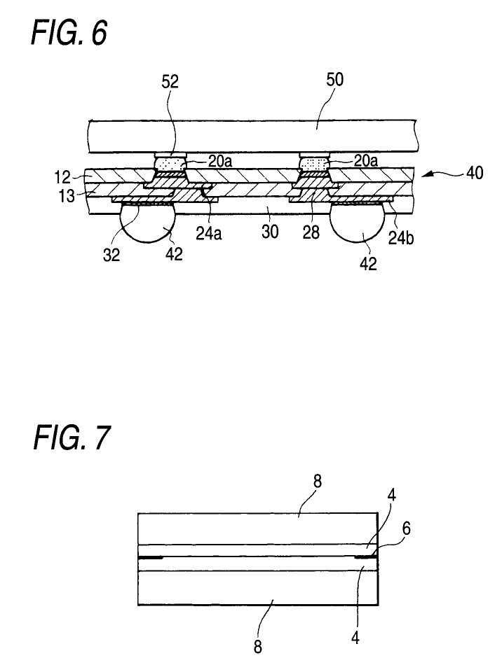

FIG. 6 shows a semiconductor device in which a semiconductor element 50 is mounted on a wiring board 40 obtained by the a fore said method. External coupling terminals 42 such as solder balls are joined to the lands 32 of the wiring board 40, and the solder bumps 20a provided on the wiring board 40 are joined to the electrodes 52 of the semiconductor element 50, respectively. Thus, the semiconductor device is obtained in which the semiconductor element 50 is electrically coupled to the external coupling terminals 42.

According to this embodiment, the wiring board provided with a desired wiring pattern can be obtained simply by merely dissolving and removing the base members 10 after forming the wiring patterns 24a, 24b in the laminated manner on the other surface of each of the base members 10 via the insulation layers 12, 13. Thus, the wiring board with the solder bumps can be formed by the efficient manufacturing procedure advantageously.

Further, according to this embodiment, at the time of pasting the base members 10,10 to each other, the mold release agent is attached to the area A of the base members 10,10, and then the base members are pasted at only the areas B by means of the adhesive agent resin sheet 11. In this case, since the thickness of the mold release agent is substantially zero, there does not arise any step portion at the time of subjecting the insulation layers 12 and 13 to the thermo compression bonding in the following procedure. Thus, the wiring pattern can be advantageously formed quite accurately.

In the aforesaid embodiment, although an example in which the wiring pattern is formed by the subtract method is shows as a method for forming a wiring pattern on the base member 10, the invention is not limited to the subtract method. For example, in the case of forming the wiring patterns on the surfaces of the insulation layers 12, 13, the wiring patterns may be formed by using the additive method or the semi-additive method.

Besides, generally, a mold release agent must be coated or printed on a metal instead of resin.

What is claimed is:

1. A method for manufacturing a wiring board comprising the steps of:
pasting two base members made of metal in a manner that one side surfaces thereof are opposed to paste to each other,
forming a wiring board formed by plural layers on the other surface of each of the base members,
separating both the base members from each other, and
removing the base members to obtain wiring boards separately, wherein
in a case of pasting the two base members, a mold release agent in a liquid state is coated or printed on a portion except for a peripheral portion of the one side surface of each of the two base members, and an adhesive agent resin sheet is disposed between the two base members to paste the peripheral portions of the base members being attached with no mold release agent to each other by the adhesive agent resin sheet.

2. The method for manufacturing a wiring board according to claim 1, wherein
a thermosetting resin sheet is used as the adhesive agent resin sheet.

3. The method for manufacturing a wiring board according to claim 1, wherein
insulation layers between the wiring boards each formed by the plural layers are formed by subjecting an insulation resin sheet to a thermo compression bonding.
